(19) United States
(12) Patent Application Publication
(10) Pub. No.: US 2013/0231997 A1
(43) Pub. Date: Sep. 5, 2013

(54) UNIVERSAL ELECTRONIC COUPON CARD

(71) Applicant: IT CARD HOLDINGS, LLC, Riviera Beach, FL (US)

(72) Inventor: Russell N. Ferguson, Riviera Beach, FL (US)

(73) Assignee: IT CARD HOLDINGS, LLC, Riviera Beach, FL (US)

(21) Appl. No.: 13/782,811

(22) Filed: Mar. 1, 2013

Related U.S. Application Data
(60) Provisional application No. 61/605,326, filed on Mar. 1, 2012.

(51) Int. Cl. G06Q 30/02

(52) U.S. Cl. CPC G06Q 30/0238
USPC 705/14.35; 705/14.38; 705/14.36

(57) ABSTRACT

The present invention relates to consumer coupons, and more specifically to an electronic coupon card and system for managing coupon distribution and redemption. The instant invention provides a system and method of securely managing an electronic coupon database which implements and manages discounts for customers without requiring the customer to actively seek out, download and/or print the coupon. Additionally, the instant invention provides a system and method for managing electronic coupon discounts and payments to retailers for redeeming electronic coupons.

### RELATED APPLICATION

### Reference to Related Application

In accordance with 37 C.F.R 1.76, a claim of priority is included in an Application Data Sheet filed concurrently herewith. Accordingly, the present invention claims priority under 35 U.S.C. §119(e) to U.S. Provisional Application 61/605,326 entitled, “UNIVERSAL ELECTRONIC COUPON CARD” filed on Mar. 1, 2012. The contents of each of the above referenced applications are herein incorporated by reference in its entirety.

### FIELD OF THE INVENTION

The present invention relates to the field of couponing, and in particular to a universal electronic coupon card that includes an electronic strip or otherwise interacts with a payment terminal at a plurality of retailers or other entities for applying coupons, rewards, memberships and other discounts.

### BACKGROUND OF THE INVENTION

Sales promotions are one of the basic marketing strategies for many companies. With the advance of technology, electronic coupons are becoming commonplace. In the past, merchants, vendors, manufacturers and the like have commonly provided paper coupons as a sales promotion through flyers, papers or at the point of purchase. More recently, paper coupons can be located on the internet or through email. The electronic coupons are typically printed from a computer screen onto paper for redemption at the point of purchase. Other systems e-mail coupons to coupon website users based upon prior search and selection of coupons.

### DESCRIPTION OF THE PRIOR ART

U.S. Patent Publication No. US 2002/0194069 discloses a business system including a magnetic strip card with consumer identifying information encoded thereon, a host system remote from the vendor location that maintains information about discounts from the vendor, an apparatus at the vendor location for reading the consumer identifying information on the magnetic strip card for automatically applying any applicable discount related to the transaction at the vendor location for the benefit of the consumer, without consumer selection and without requiring consumer awareness of any of the applicable discounts.

U.S. Patent Publication No. US 2007/0282679 discloses a portable plastic coupon card having coupons digitally encoded thereon that is swiped through a reader so that a particular digitally encoded coupon can be redeemed upon verification by the store server that the item is redeemable, whereupon an electrical transmission from the store server to the particular checkout register causes that item to be redeemed and displayed as a coupon redeemable purchase on the printed receipt provided to the individual.

U.S. Patent Publication No. US 2009/0018908 discloses a paperless online system for issuing a magnetic stripe Coupon Card to retail customers (cardholders) upon registration. Each Electronic Coupon has descriptive data supplied by product Manufacturer or Service Provider, electronically stored in a Central Database, and is formatted to be displayed online for browsing and selection. Each Electronic Coupon can be linked to a card of any cardholder interested in receiving the discount designated by the Electronic Coupon. The Electronic Coupon does not contain a barcode and does not need to be printed out in order to be redeemed.

U.S. Pat. No. 5,484,988 discloses a point of sale system designed to read information from a consumer's check, credit card, or manual input with a subsequent debiting of a consumer's account and crediting a merchant's account for the goods or services provided. Point of sale terminals are designed to accept a form of credit card with a consumer's bank account information encoded thereon, or in the alternative to read the MICR number from a consumer's check in order to verify that a consumer has an appropriate balance to conduct the transaction with a given merchant. The system eliminates the need for paper checks with all bank reconciliation being accomplished electronically.

U.S. Pat. No. 6,009,411 discloses a method and system for distributing and redeeming electronic promotions to a consumer through the Internet. An account which is associated with a unique key is maintained for each consumer account. The consumer is presented discount or other promotional choices of items available in at least one store (or a collection of such stores) associated with the key over the Internet, and the selections of the discount or promotional choices made by the consumer over the Internet are recorded. Upon purchase of items at the associated store by the consumer, selections and purchases are reconciled to record a credit in the customer account.

U.S. Pat. No. 6,075,971 discloses a method and apparatus for targeting specific audiences for coupon distribution. In one embodiment, users of an entertainment network are monitored or surveyed to determine specific preferences. A preference profile is determined and coupons are distributed only to the users that fit a coupon distributor's chosen preference profile. The coupons may be downloaded to a user's system or coupons may be mailed to the user.

U.S. Pat. No. 6,691,915, discloses an electronic coupon system and a method of processing electronic coupons. The system utilizes a coupon card on which data representing selected coupons may be stored for subsequent redemption at a point-of-sale terminal. A host computer is in communication with an in-store kiosk and the point-of-sale terminal. The in-store kiosk includes a user interface and a coupon card interface. The point-of-sale terminal includes a transaction data interface and a point-of-sale coupon card interface. The coupon data processor is programmed to correlate the transaction data with the coupon data read from the coupon card by the coupon card interface and to reduce the product sale price by an amount indicated in the coupon data.

U.S. Pat. No. 7,783,532 discloses a system for handling electronic coupons that includes accessing information indicating association of an electronic coupon with an account of a user that identifies multiple retail entities associated with the user. The computer systems may associate electronic coupons with the user such that the user may redeem the electronic coupons at a retail store upon presentation of a user identifier.

U.S. Publication No. 2002/0107738 discloses a system for reducing cost or burdens associated with conventional couponing. In one aspect, a user registers, e.g., at a web site, the user's identification number or other number, and the user's bank account or other account. The user preferably identifies one or more coupons which are desired. After the user visits a retail location and makes purchases, a program in communication with the retail location point-of-sale computer verifies compliance with coupon criteria and authorizes or requests an appropriate monetary credit or deposit in the user's bank (or other) account.

U.S. Publication No. 2002/0188505 discloses an apparatus and method for an electronic savings card. A Store Method and A Cellular Carrier Method. In the store method, a portable electronic device, like a cellular phone, transmits user data to the store's cash register identifying the shopper. The store's cash register then discounts the customer's bill accordingly and may optionally transmit customer and product data to a central computer. In the Cellular Carrier Method, the store's cash register transmits store identification data to a cellular phone. The cellular phone then sends store, customer and product data to the cellular carrier for data processing.

U.S. Publication No. 2004/0140361 discloses a system and method for real-time validation and redemption of paper and electronic coupons;

U.S. Publication No. 2005/0080728 discloses methods for accounting, administration and processing of transactions utilizing a stored value card utilizing an EFT service gateway and providing balances for the cards across a plurality of point of sale devices. One method includes receiving a message generated by the point of sale system of a merchant and parsing the message into data elements. A message is formatted and one of an authorization approval or a denial based upon the determination is transmitted within the message.

U.S. Publication No. 2005/0234771 discloses an intelligent in-store couponing system comprising an operating computer for controlling the functions of the intelligent in-store couponing system; a coupon database capable of storing coupons and coupon data or information; a coupon management module for managing the coupons and their delivery; and at least one coupon delivery system capable of delivering a coupon to a customer in a usable format at the point-of-sale and/or point-of-decision.

U.S. Publication No. 2009/0106115 discloses a system that automates the clearing and settlement of electronic coupons (E-Coupons). After registering and selecting coupons, consumers then use an E-Coupon card or account access device at a merchant's point-of-sale (POS) terminal. E-Coupon values are deducted from the consumer's final amount due. Both consumer package goods manufacturers (CPGs) and merchants may be charged a fee. Expired coupons are automatically removed from the account and their value refunded to the CPGs.

U.S. Publication No. 2010/0017277 discloses a system and method for an electronic coupon service using a smart card. The method includes the steps of: issuing, by an electronic coupon server, an electronic coupon to an authenticated user smart card at the request of a user who wants the electronic coupon to be issued; distributing, by a service terminal, the electronic coupon, which has been issued by the electronic coupon server to the user smart card when the user smart card is inserted into the service terminal; and transferring, by the service terminal, the electronic coupon stored in the user smart card to a service provider smart card at the time of providing the service by the service provider, and provides an electronic coupon service system using the smart card which can achieve the method.

U.S. Publication No. 2010/0312632 discloses a method where, at a web service, a selection of an electronic coupon from a database is received from a web browser. The electronic coupon is associated with the account of the electronic coupon sponsor and is receivable by a merchant for a discount which is debited from the sponsor's account and credited to the merchant's account. A specification is then received that includes the rendering capability of the client, a type of portable coupon device associated with a consumer account and acceptable as payment for a future purchase, and an identifier of the consumer account. Next, a rendering image, a location to store the discount information in the memory of the type of the portable coupon device, and the discount information is retrieved from the database. Finally, the web browser transmits, via the web service, the rendering image, memory location, and discount information.

U.S. Publication No. 2010/0312633 discloses a method for use in a payment processing network. The method includes browsing to an Internet website in communication with a web service having a database storing electronic coupons. Each electronic coupon is associated with a sponsor's account and is receivable by a merchant for a discount, where the discount is debited from the sponsor's account and credited to the merchant. The browser sends the selected electronic coupon and a specification including the rendering capability of the client, the type of portable coupon device, and an identifier for the consumer account associated with the portable coupon device. The browser then receives a rendering image, the memory storage location for the discount information, and the discount information, which includes identifiers for the sponsor account, the discount amount, and the eligible purchase. Finally the discount information is written to the memory of the portable coupon device.

U.S. Publication No. 2010/0312634 discloses a method of using a point of service terminal (POS) to provide a discount on a purchase. The method includes receiving a portable coupon device associated with a consumer account. Stored in the memory of the portable coupon device is an electronic coupon associated with a sponsor account and which is receivable by a merchant for a discount on a purchase, the discount being debited from the sponsor's account.

U.S. Publication No. 2010/0312635 discloses a portable coupon payment device which includes a substrate having surface with an image rendering thereon that corresponds to a free sample. The portable coupon payment device also has memory, in contact with the substrate, having data encoded therein including (i) an identifier for the free sample, (ii) a quantity for the free sample; (iii) a sponsor company account for a selling merchant to charge the cost of the free sample for payment to a selling merchant account to reimburse the selling merchant for the free sample; (iv) an image corresponding to the free sample; and (v) an identifier for a coupon provider donating the free sample to a consumer.

U.S. Publication No. 2011/0251884 discloses handling electronic coupons by accessing information indicating association of an electronic coupon with an account of a user that identifies multiple retail entities associated with the user. Information indicating association of electronic coupons with the user's account may be transmitted to respective computer systems associated with the multiple retail entities. The computer systems may associate electronic coupons with the user such that the user may redeem the electronic coupons at a retail store upon presentation of a user identifier. When the user redeems an electronic coupon, cancellation information for the electronic coupon may be transmitted to the computer systems of other retail entities associated with the user.

### SUMMARY OF THE INVENTION

The present invention relates to consumer coupons and more specifically to an electronic coupon card and system for managing coupon distribution and redemption. The instant invention provides a system and method of securely managing an electronic member and coupon database which implements and manages discounts for customers without requiring the customer to actively seek out, download and/or print the coupon. Additionally, the instant invention provides a system and method for managing electronic coupon discounts and payments to retailers for redeeming electronic coupons. While the present invention is illustrated as a physical card, the method and steps of the invention disclosed herein may also be applied as a phone application without departing from the scope of the invention.

Accordingly, it is an objective of the instant invention to provide a rewards/shopping/coupon/membership card for use at multiple retailers or other entities. The coupon card allows a customer to have a single reward/shopping/coupon/membership card that manages rewards, memberships and coupons across retailers or other sales entities. The coupon card may exist as a standalone card, or may exist as a coupon card combined with existing cards, such as a credit card.

It is a further objective of the instant invention to provide a quick and seamless rewards signup for new customers. Retailers or other entities have the opportunity to sign up a not yet enrolled and participating customer. Therefore, a system and method is provided to easily sign up new customers who are not yet enrolled in the coupon card program.

It is yet another objective of the instant invention to provide an electronic coupon system and method where manufacturers and other entities can release electronic coupons to the system that will process at the point of sale.

It is a still further objective of the invention to provide a system and method to securely manage customer information.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a flow diagram of the card tracking arrival;

FIG. 2 is a flow diagram of the card shipping;

FIG. 3 is a flow diagram of the new cardholder setup;

FIG. 4 is a flow diagram of the IT process at retailer location;

FIG. 5 is a flow diagram of the coupon creator editor;

FIG. 6 is a flow diagram of the coupon card verification for renewal and deactivation;

FIG. 7 is a flow diagram of the payment processing;

FIG. 8 is a flow diagram of the IT network;

FIG. 9 is a flow diagram of the back office suite.

### DETAILED DESCRIPTION OF THE INVENTION

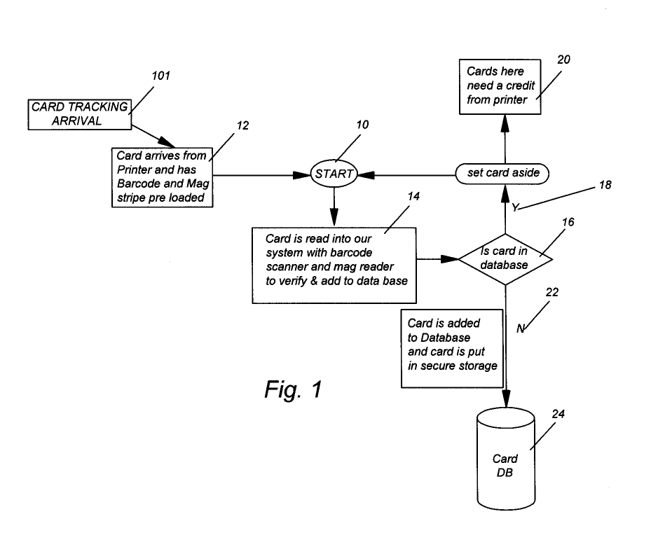

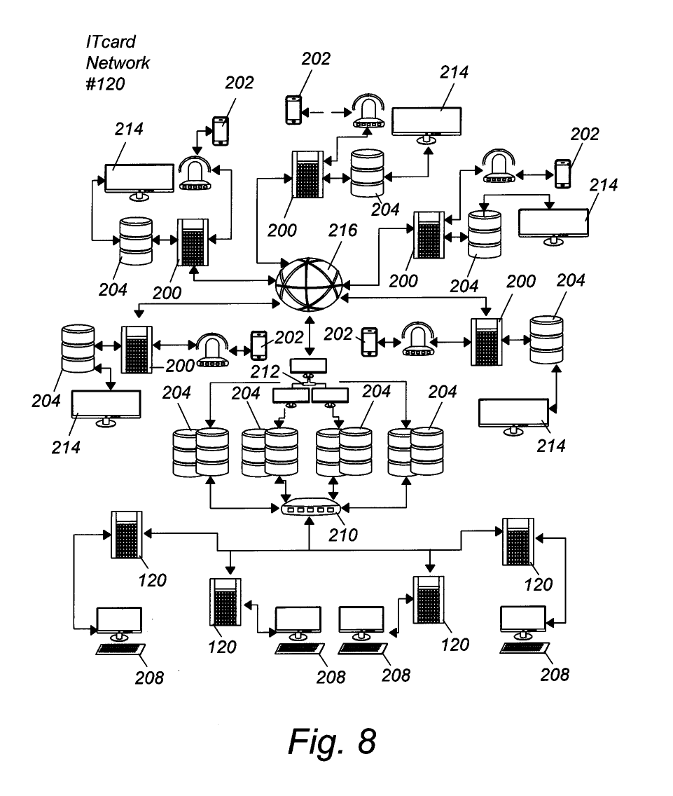

Shown in FIGS. 1-9 is a system and method for providing a rewards/shopping/coupon/membership card for use at multiple retailers or other entities. The system includes the card as well as coupon distribution and coupon redemption. The coupon card allows a customer to have a single reward/shopping/coupon/membership card that manages rewards and coupons across retailers and other entities. The coupon card is presented by a customer at the point of sale to a retailer or other entity and includes coupon offers from national manufacturers and retailers to be applied to store bought items. The coupon card may exist as a standalone card, or may exist as a coupon card combined with existing cards, such as a credit card.

The coupon distribution portion of the system maintains the internal process of collecting customer information. Additionally, the coupon distribution portion couples to remotely located retailer or other entity computers to provide discounts to be applied to the price of products or services at the point of payment. A wide variety of products and services may be discounted, including retail shopping, restaurant items, hotel and air travel, government programs, and other similar products and services.

Referring now to FIG. 1, shown is the process of coupon card tracking arrival (step 101). Typically, retailers or the entity accepting the card will receive the cards. The process may be setup, such that a card may be received from a printer 12. The received card includes a barcode and a magnetic stripe or smart-card chip with preloaded information 12. The preloaded information may include a primary account number, a customer name, expiration date and other discretionary data such as pin verification keys, values and codes. Additionally, the card may include a bar code, data matrix code or Universal Product Code for providing a unique identifier to the system.

The card is read into the system with an appropriate scanner or a magnetic reader 14. Once the card is read into the system, the system shall verify the card and determine whether the card is in the database at step 16, e.g. valid. If the card is in the database, then the card shall be set aside for distribution at step 18 for use; or discarded if invalid, and a reimbursement for the cost of the card may be provided by the printer 20. If the card is not in the database 22, then the card information is stored into the card database 24.

The card database 24 will store card information that has not been previously stored into the system. Only cards that arrived from being printed and having pre-loaded information shall be capable of becoming active. For security, only active cards in the card database 24 will be capable of use.

The system shall be capable of monitoring for excessive use of any particular card that is stored in the card database 24. Excessive use may indicate that a particular coupon card has been duplicated or any other abuse towards the system. In the event that excessive use is detected by the system, an alert will be generated for investigation. The alert may include an audio or visual alert. For example, the system may generate a report of the cards usage. That usage may include a specified time period, such as over the past 30 days with retailer or other entity locations, times that the card was used, and discounts provided.

The card database 24 will store information relating to pending coupon card activation. Coupon cards are considered pending when received through a particular retailer entity and prior to activation. Additionally, the card database 24 will store information relating to location of a coupon card at the point of activation. The card database 24 shall include a list of all corporate inventories of coupon cards and their location. The card database 24 shall have a list of all coupon cards that have expired and are awaiting renewal. Furthermore, cards that have expired for more than sixth months will be stored in the card database 24 as deactivated. In a deactivated status, the card will not provide reward benefits, such as coupon discounts. Furthermore, coupon cards saved into the card database 24 as deactivated will be permanently disabled and typically cannot be renewed.

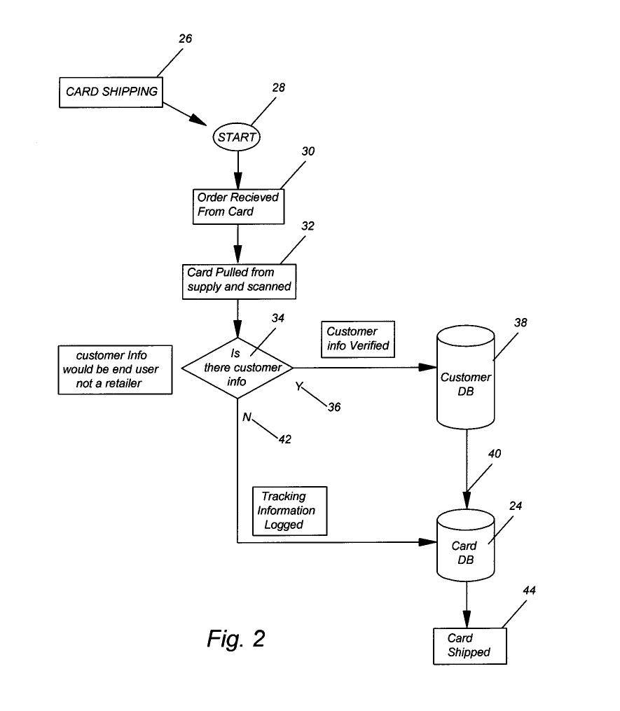

Referring now to FIG. 2, shown is a process for card shipping. An order is received for a coupon card 30. The order is received relating to a new or current customer. The order will be placed by either the customer/end user or by the retailer or entity wishing to sell the card. After receiving a card order, the card is picked from a supply of coupon cards and scanned 32. The system determines whether there is customer information available to pair with a coupon card 34.

Subsequent to receiving an order for a coupon card 30, the order shall ship to the customer 44. If customer information is available when the order is received; the customer information is then verified. The verification request 36 is sent to the customer database 38. The customer database stores active customer information. The customer must “opt in” in order for that information to be made available. This information may be transferred to the customer database 38 from the retail location during activation or at a later point in time. The customer database 38 includes information that the retailer, vendor, manufacturer or other entity may request for purposes such as demographics. After customer information is transferred to the customer database 38, that customer information is linked 40 to the card database 24.

If the customer information is not available when the order is received, then the coupon card information is stored in the card database 24 without linking to the customer database 38. Nonetheless, tracking information may be logged 42.

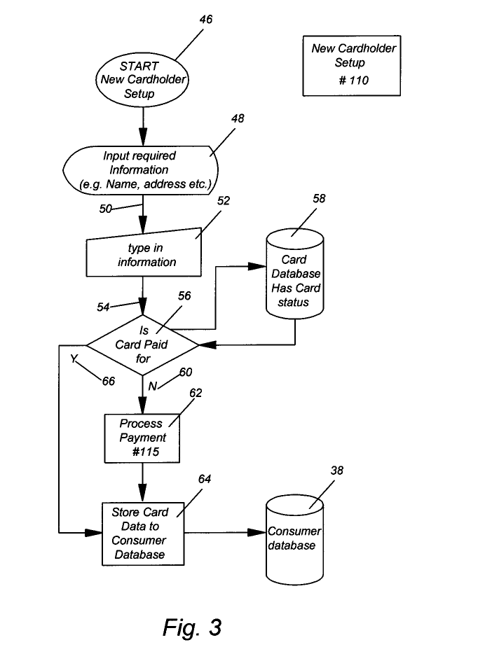

Referring now to FIG. 3, a new cardholder setup 46 is illustrated. Information containing a customer name and correspondence details are required 48. The information may further include unique coupon card identification codes. The information is prompted for entry 52. The required information may be typed or otherwise entered into the system. Subsequently, that required information is sent to the system server and directed to the proper location 54. After receiving the required information, the system shall determine whether the new coupon card is paid for 56 by invoking the card database 24 for the status of the coupon card 58.

If the new coupon card is not paid for 60, then the system shall process payment 62 for the coupon card. After processing payment, the system shall invoke a routine to store coupon card data to the customer database 64. If the new coupon card is determined to be paid for at the retailer start 66 after invoking the card database for the card status 58, then a routine is invoked to store coupon card data 64 to the customer database 38.

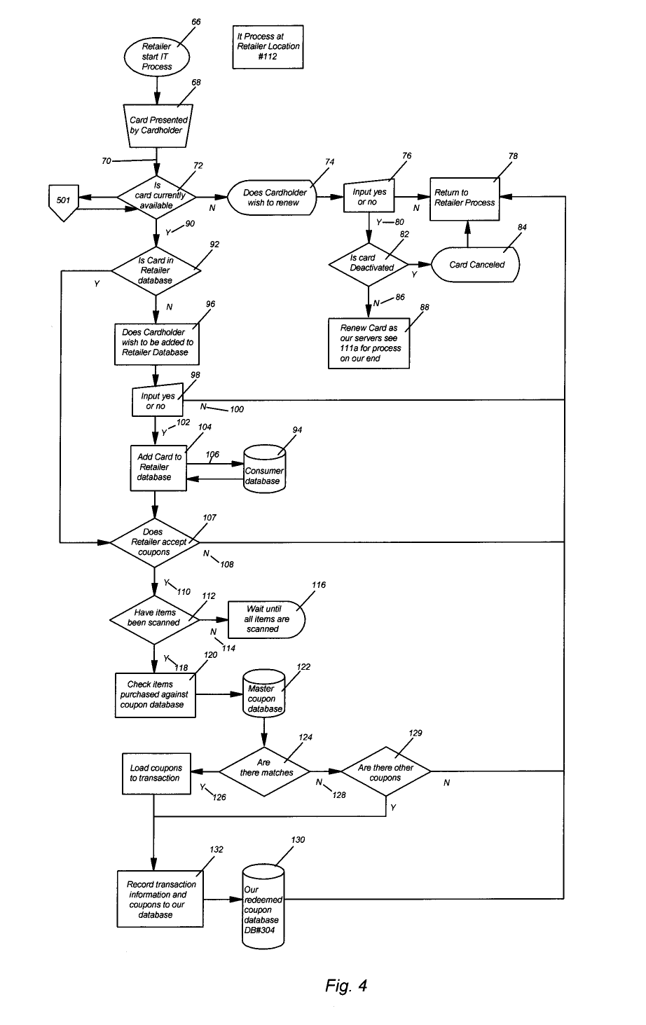

Referring now to FIG. 4, a retailer IT process 66 is illustrated. At a retail or other entity accepting the card location, a coupon card is presented by a customer 68. Information from the coupon card is read into the system 70. The system will invoke the card database 24 to determine whether the card is currently active 72. If the coupon card is not currently active (step 73), the system will display a message to the customer to determine whether the customer wishes to renew the coupon card 74. The system shall allow the customer to select whether or not the customer wishes to renew the coupon card 76. Selecting “no” shall return checkout point of purchase to the retailer or sale entity checkout process 78. If the customer selects “yes” to renew 80, the system shall invoke the card database 24 to determine whether the card has been deactivated or otherwise canceled 82. When the data base returns a value to indicate that the card has been deactivated or otherwise canceled 84, the system may display a message indicating that the card is deactivated and shall return to the retailer checkout process 78. If the coupon card is not deactivated 86, the system shall renew the coupon card 88. The renewed coupon card status shall be stored to the card database 24. If the coupon card is currently active or has been renewed (step 90, step 88), then the system shall ascertain whether information relating to the coupon card is located in a retailer database 94.

The retailer or sales entity database 94 will contain multiple databases. Retailers or sales entities will be assigned a unique identifier, such as a number followed by a letter, which associates that retailer or sales entity to a database within the retailer database 94. In this manner, different databases within the retailer database 94 separate information that relates to a particular retailer or sales entity. The retailer database 94 stores new and renewal revenues for each particular retailer or sales entity, information on coupons redeemed at each particular retailer, information relating to coupon redemption during previous quarters, and information relating to previous quarters signup information. The system may generate reports to be delivered to retailers or sales entities.

If information relating to the coupon card is not located in the retailer or sales entity database 94, the system shall prompt the customer on a display to determine whether the customer wishes to be added to the retailer or sales entity database (step 96). Either the customer or the retailer shall input whether the customer will be added to the retailer database (step 98). If the customer does not wish to be added to the retailer or sales entity database (step 100), then selecting “no” shall return checkout point of purchase to the retailer checkout process (step 78). Alternatively, if the customer wishes to be added to the retailer or sales entity database (step 102), a process is invoked to add the coupon card to the retailer database 94 (steps 104, 106).

The system shall next determine whether the retailer or sales entity accepts coupons (step 107). If the retailer or sales entity does not accept coupons 108, the process shall return checkout point of purchase to the retailer checkout process (step 78).

If the retailer or sales entity does accept coupons 110, then the process shall wait until all items have been scanned. Typically, the cashier or other agent of the retailer or sales entity shall indicate that all items have been scanned. If the system has not received notification that all items have been scanned 114, the system will wait (step 116). When the system receives notification that all items have been scanned 118, a system server 120 invokes a process to check the scanned items against a master coupon database 122. If there are coupon matches 126, the server 120 will transmit and load coupon information to the remote retailer or sales entity computers.

Additionally, information shall be recorded to evidence the use of the coupon on the master coupon database 122. A redeemed coupon database 130 shall reflect the use of a coupon (step 132). It should be noted that the card holder does not need to search out and load the coupons prior to shopping. The system will search the database for coupons that can be applied to products purchased by the card holder. If coupons are in the database, the coupons are automatically applied to the purchase.

The redeemed coupon database 130 contains a master list of all redeemed coupons, with location and transaction number. The redeemed coupon database 130 provides an accounting of the revenues owed to the system administrator from the manufacturers for coupons that have been redeemed at a retail level. The database may be closed at the end of each month and a new database opened to maintain monthly accounting of the redeemed coupons. Alternatively, the database may be closed at the end of a quarter, at the end of a year, or at any other interval desired. The redeemed coupon database 130 may contain information relating to both electronic coupons, as well as paper coupon information. Similarly, the redeemed coupon database 130 is capable of tracking usage and other information relating to both redeemed electronic coupons and paper coupons.

If there are no coupons (steps 128, 129), the process shall return checkout point of purchase to the retailer checkout process (step 78). Likewise, after recording used coupons into the redeemed coupon database 130, the process shall return checkout point of purchase to the retailer checkout process (step 78).

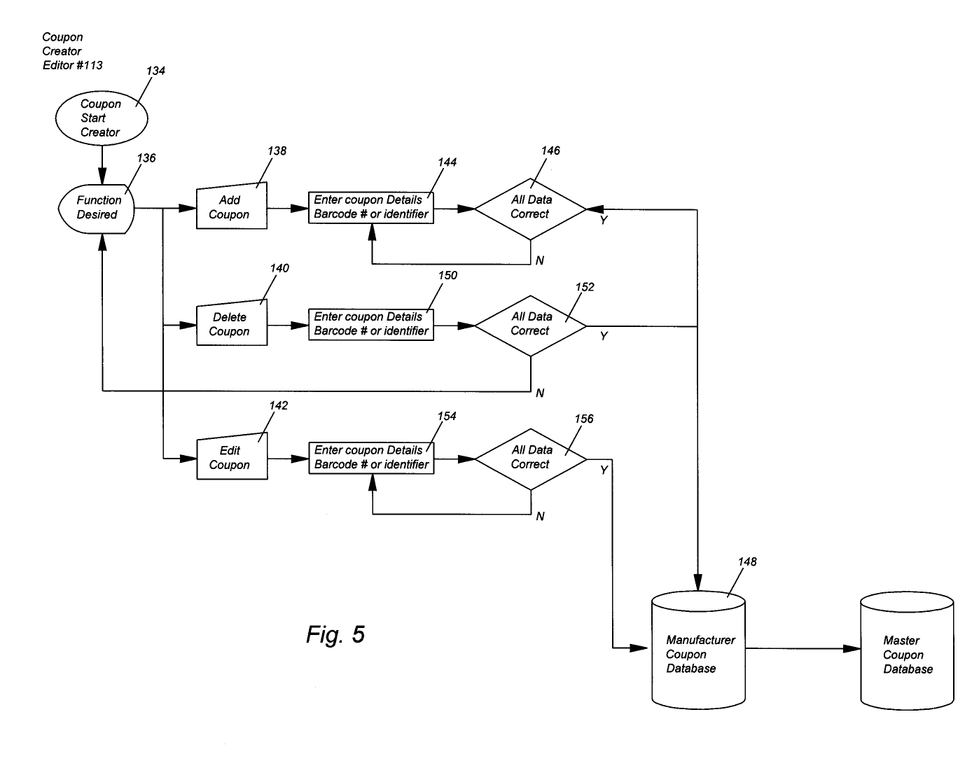

Referring now to FIG. 5, a method of coupon creation using the coupon creator 134 over the Internet is illustrated. A list of desired functions 136 are expressed graphically to a participating manufacturer or retailer of the coupon creation. From that list of desired functions 136, the participating manufacturer or retailer shall select add coupon 138, delete coupon 140 or edit coupon 142.

The system provides for participating manufacturers and/or retailers to add and delete coupons to the system as desired. When add coupon 138 is selected by a participating manufacturer or retailer, the system shall display a request to enter coupon details 144 including a barcode number, value of coupon discount or other unique identifiers and information. Subsequent to receiving coupon information, the system shall ask whether all the data was entered correctly 146. If the data was not entered correctly, the system shall allow the information to be corrected. After all the data is correct, the new coupon shall be added to a manufacturer database 148.

When delete coupon 140 is selected by a participating manufacturer or retailer, the system shall display a request to enter the coupon details 150. Subsequent to receiving coupon information, the system shall verify whether the information is correct. If the system determines that the coupon information entered at step 150 is incorrect, then the system shall return to receive a new desired function 136 of a participating manufacturer or retailer. If the coupon information relates to a valid coupon 152, the system may verify that the participating manufacturer or retailer intends to delete the coupon. After the system verifies that the participating manufacturer or retailer intends to delete the coupon, the coupon is deactivated in the manufacturer coupon database 148.

When edit coupon 142 is selected by a participating manufacturer, retailer or other sales entity, the system shall permit entry of coupon bar code or other identifier. After receiving coupon bar code or other identifier, the system shall display the current coupon relating to the entered identifier. Moreover, the system shall permit a participating manufacturer, retailer or other sales entity to modify information relating to the current coupon, such as who qualifies for the coupon, where the coupon may be used, how many times a coupon may be used, the value of the coupon, the expiration date of the coupon and other similar information. The modified information shall be verified prior to saving the modified information to the manufacturer coupon database 148. The system shall verify whether the modified information was entered correctly 156. If the modified information is determined to be entered incorrectly, the modifications will not be saved to the manufacturer coupon database 148 and will permit further modification of coupon information.

The manufacturer database 148 may contain a unique database for each manufacturer for which coupons are associated in the manufacturer database 148. The manufacturer database will contain current coupons for a plurality of manufacturers. Furthermore, the manufacturer database 148 will contain information relating to specific transactions including redeemed coupons for a particular transaction, and should further include information relating to location, time, transaction number, employee number and/or other pertinent customer information.

Once coupon information has been added, deleted, edited or otherwise modified in the manufacturer coupon database, the information shall be saved to the master coupon database 122.

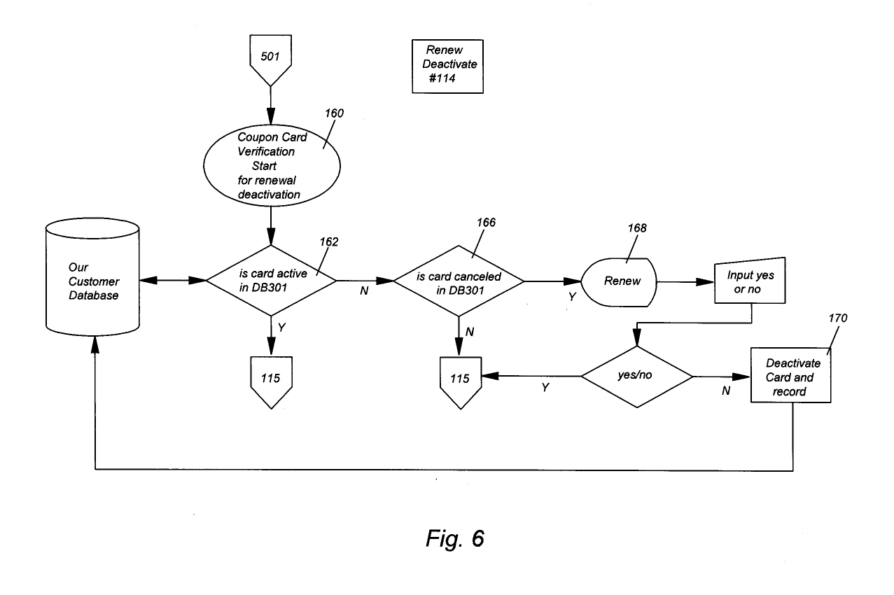

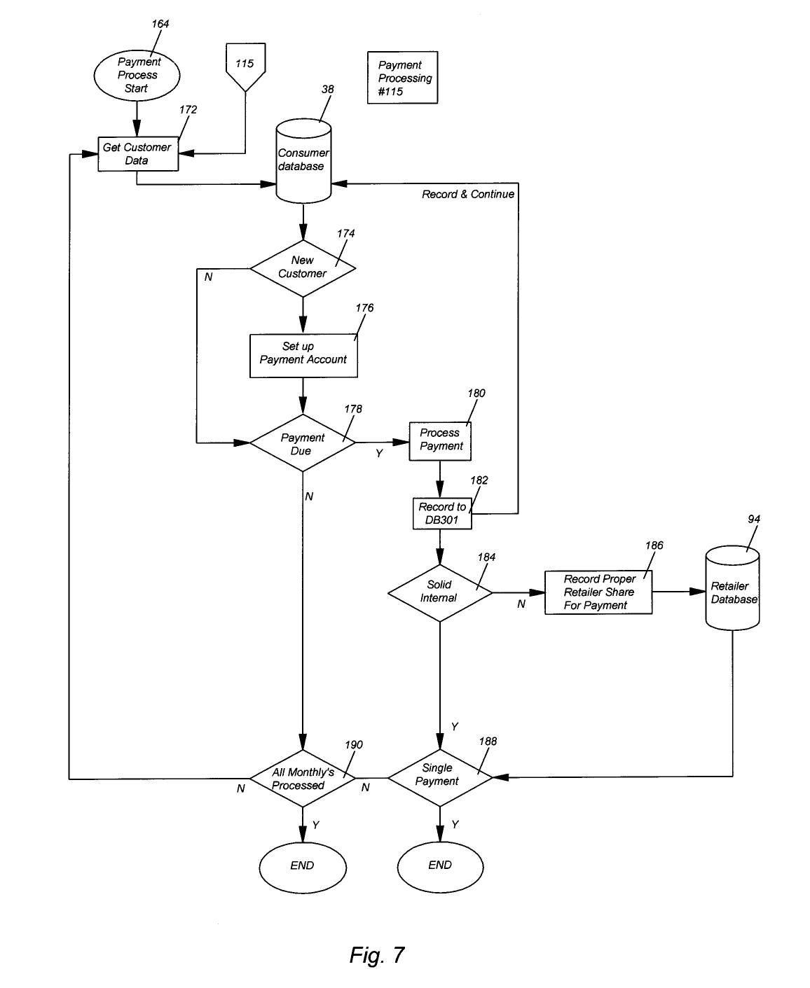

Referring now to FIG. 6, a process of coupon card verification for renewal and deactivation 160 is illustrated. The coupon card is initially identified to the system. The coupon card may be identified from information located on the coupon card magnetic strip, smart card or otherwise entered or identified to the system. Once identified, the system will query the customer database 38 to ascertain whether the coupon card is active 162 as stored within the customer database 38. If the customer database 38 returns a value indicating that the coupon card is active (FIG. 6), the process will move to the payment process start 164 (FIG. 7).

If the coupon card is not active, the system will use information queried from the customer database 38 to determine whether the coupon card is cancelled 166. If the customer database 38 returns a value indicating that the coupon card is not cancelled (FIG. 6), the process will move to the payment process start 164 (FIG. 7). If the customer database 38 returns a value indicating that the coupon card is cancelled, the system shall request renewal 168 of the cancelled coupon card. Renewal of the card shall move the process to the payment process start 164. If the cancelled card is not renewed 170, the coupon card shall be stored as deactivated within the customer database 38.

Referring now to FIG. 7, a payment process beginning at step 164 is illustrated. Customer data is requested at step 172 from the customer database 38. The customer database 38 will provide information that indicates whether the customer is new 174. If the customer is new, then a new payment account must be setup 176. The customer database will return information indicating whether payment is due for both new and existing customers at step 178. When payment is due at step 178, the payment is processed at step 180 and recorded at step 182 to the customer database 38. The coupon card may be sold through an internal mechanism. Alternatively, the coupon card may be sold to the customer externally through a retailer or sales entity. At step 184, an inquiry is made to indicate whether the coupon card was sold internally or externally. An external coupon card sale shall be recorded to provide proper retailer share for payment 186 and stored within the retailer database 94. At step 188, an inquiry is made to ascertain whether a single payment is due. If a single payment is not due, then an inquiry is made at step 190 to determine whether all monthly payments are processed.

Referring now to FIGS. 5-8, the architecture of an exemplary network of the instant invention is illustrated. Specifically depicted is a modular coupon card management system comprising, a central database system 204 having a card database 24, customer database 38, a retailer database 94, a master coupon database 122, a redeemed coupon database 130 and a manufacturer database 148.

The modular coupon card management system is comprised of at least one computer 208 that interfaces with a management server 120. The at least one computer 208 accepts input from a keyboard and mouse to add, delete and edit coupons. The at least one computer may be remote, located at a manufacturer or a retail establishment. The server is routed 210 to the central database system 204. In an exemplary embodiment, a plurality of remote systems comprised of remotely located retail or other sales entity computers 214, remotely located retail databases 206 and remotely located retail servers 200 request information from the modular coupon card management system. The remote system transmits the request via the internet 216 to the modular coupon card management system 212. The transmission request is instigated after a remotely located retail computer 214 receives a coupon card identity. The modular coupon card management system will return information over the internet 216 that provides coupon discounts to applicable items at the point of sale.

The customer does not need to take any action to add coupons to his/her account. Instead, applicable coupons that relate to items at the point of sale will be automatically applied at the point of sale. In addition to applying coupons at the point of sale, each remote system may instigate new card holder setup (step 46), retailer process (step 66), coupon card verification (step 160), and coupon card payment processing (step 164).

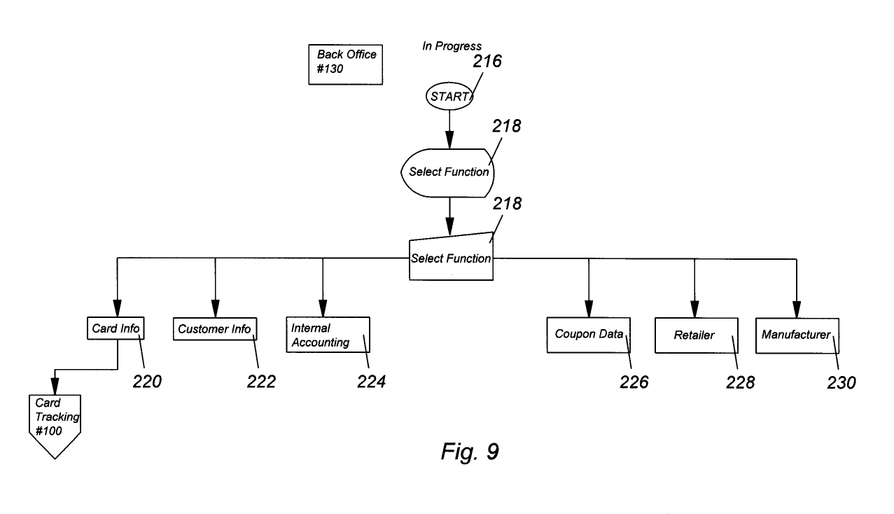

Referring now to FIG. 9 a back office suite starting at step 216 is illustrated. A select function 218 permits selection of one of card info 220, customer info 222, internal accounting 224, coupon data 226, retailer information 228, and manufacturer information 230.

The system of the present invention also includes a system for redemption of the coupons from manufacturers, retailers and other sales entities. Typically, the cashiers must count the coupons for settling up their cash drawers. Managers must then recount the coupons for transfer to clearing house that again recounts the coupons, determines their validity and transfers them to the manufacturer for reimbursement. The clearing house takes their cut of the coupon reimbursement cash and the remainder of the money is finally transferred back to the retail establishment that accepted the coupon. The present system eliminates most of these steps by automatically totalling the value of the coupons for balance transfer to the retailer electronically at the end of the day or at whatever time they request a total. The coupons are also sent electronically to the company that issued the coupon for electronic balance transfers to the card managers for electronic balance transfers to the retailer.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of electronically distributing coupons to consumers including the steps of:
providing a coupon card to a consumer, said coupon card having electronic data storage thereon;
presenting said coupon card at a point of sale;
providing a system server, said system server having an electronic database of coupons thereon, said system server being remote from said point of sale;
providing a reader for interpreting said electronic data storage at said point of sale;
scanning a list of products to be purchased;
providing an electrical communication between said system server and said point of sale;
providing a search engine for searching said electronic database of coupons for comparison to said list of products to be purchased at said point of sale;
returning a list of coupons related to said list of products to be purchased;
applying said list of coupons to a purchase price of said list of products to be purchased.

2. The method of electronically distributing coupons to consumers of claim 1 including:
compiling a list of coupons utilized across multiple points of sale in said system server;
compiling a list of point of sale companies where said coupons were redeemed;
distributing said list of coupons redeemed and said list of point of sale companies to originators of said coupons, whereby an electronic transfer of funds commensurate to the value of said coupons utilized is initiated to said point of sale companies.

3. The method of electronically distributing coupons to consumers of claim 1 wherein said list of products to be purchased is a list of services to be purchased.

4. The method of electronically distributing coupons to consumers of claim 1 wherein said electronic data storage on said coupon card includes customer information relating to said consumer including name, address and purchasing history.

5. The method of electronically distributing coupons to consumers of claim 4 wherein said reader copies said customer information to an on-site storage medium at said point of sale.

6. The method of electronically distributing coupons to consumers of claim 4 wherein said reader includes a writing function for depositing said customer information to said electronic data storage on said coupon card.

7. The method of electronically distributing coupons to consumers of claim 4 wherein said system server includes a coupon card database, said coupon card database including an electronic storage medium for storing said customer information, said customer information being accessible from said point of sale via said electrical communication.

8. The method of electronically distributing coupons to consumers of claim 7 wherein said coupon cards are issued at said point of sale and wherein information regarding the location of said coupon cards that have not yet been issued to a consumer is stored on said coupon card database.

9. The method of electronically distributing coupons to consumers of claim 8 wherein records of said point of sale card issuance are retained in said system server whereby said point of sale company receives a monetary benefit for issuance of said coupon card.

10. The method of electronically distributing coupons to consumers of claim 1 wherein said coupon cards are issued through a remote site via internet.

11. The method of electronically distributing coupons to consumers of claim 10 wherein said coupon cards are purchased, said coupon card having a predetermined period of use.

12. The method of electronically distributing coupons to consumers of claim 1 wherein a manufacturer may directly enter a coupon into said database of coupons via an internet connection.

13. The method of electronically distributing coupons to consumers of claim 12 wherein direct entry of said coupon into said database coupons includes information regarding the value of the coupon and how many times said coupon may be used by a consumer and expiration date of said coupon.

14. The method of electronically distributing coupons to consumers of claim 1 wherein said system server stores information relating to the location of the coupon request and time of coupon request.

15. The method of electronically distributing coupons to consumers of claim 1 wherein said system server includes a card database, a customer database, a retailer database, a master coupon database, a redeemed coupon database and a manufacturer database.

16. The method of electronically distributing coupons to consumers of claim 1 wherein said coupon card is combined with a credit card.

17. The method of electronically distributing coupons to consumers of claim 7 wherein said coupon card database monitors and stores rewards available through multiple points of sale.

18. The method of electronically distributing coupons to consumers of claim 7 wherein said point of sale requests information from said coupon card database regarding rewards available to a card holder, said coupon card database returning information regarding said rewards to said point of sale for application to a purchase.

19. The method of electronically distributing coupons to consumers of claim 4 wherein said customer information is transferred to said point of sale for storage in a point of sale database.

20. A method of electronically distributing coupons to consumers including the steps of:
providing a coupon card to a consumer, said coupon card having electronic data storage thereon;
presenting said coupon card at a point of sale;
providing a system server, said system server having an electronic database of coupons thereon, said system server being remote from said point of sale;
providing a reader for interpreting said electronic data storage at said point of sale;
scanning a list of products to be purchased;
providing an electrical communication between said system server and said point of sale;
providing a search engine for searching said electronic database of coupons for comparison to said list of products to be purchased at said point of sale;
returning a list of coupons related to said list of products to be purchased;
applying said list of coupons to a purchase price of said list of products to be purchased;
compiling a list of coupons utilized across multiple points of sale in said system server;
compiling a list of point of sale companies where said coupons were redeemed;
distributing said list of coupons redeemed and said list of point of sale companies to originators of said coupons, whereby an electronic transfer of funds commensurate to the value of said coupons utilized is initiated to said point of sale companies.
